(19) United States
(12) Patent Application Publication
(10) Pub. No.: US 2026/0023373 A1
(43) Pub. Date: Jan. 22, 2026

(54) APPARATUS, METHOD, AND NON-TRANSITORY COMPUTER READABLE MEDIUM

(71) Applicant: Yokogawa Electric Corporation, Tokyo (JP)

(72) Inventors: Yanyan LIN, Tokyo (JP); Liu ZHUO, Tokyo (JP); Juan Esteban Rodriguez Ramirez, Tokyo (JP)

(21) Appl. No.: 19/260,590

(22) Filed: Jul. 6, 2025

(30) Foreign Application Priority Data
Jul. 19, 2024 (JP) 2024-116174

(51) Int. Cl. G05B 23/02; G01M 99/00; H04L 67/12

(52) U.S. Cl. CPC G05B 23/0221; G01M 99/00; H04L 67/12

(57) ABSTRACT

Provided is an apparatus including: an acquisition unit which acquires measurement values corresponding to outputs of a plurality of sensors for monitoring states of a plurality of facilities; an identification unit which identifies, based on the measurement values acquired by the acquisition unit, which abnormality type of abnormality among a plurality of abnormality types determined in advance has occurred in which facility among the plurality of facilities; and an output unit which outputs information indicating the facility and the abnormality type identified by the identification unit, and the identification unit identifies, for at least one facility, which abnormality type of abnormality among two or more abnormality types determined in advance has occurred.

The contents of the following patent application(s) are incorporated herein by reference:
NO. 2024-116174 filed in JP on Jul. 19, 2024.

### BACKGROUND

### 1. Technical Field

The present invention relates to an apparatus, a method, and a non-transitory computer readable medium.

### 2. Related Art

Patent Document 1 and Non-Patent Documents 1 and 2 describe, for example, that “a plurality of state values corresponding to measurement values of a plurality of sensors 110 are selected according to a change width or a change rate, and the selected state values are sorted and displayed according to the change width or the change rate.” (Paragraph 0033 of Patent Document 1).

### PRIOR ART DOCUMENTS

### Patent Document

Patent Document 1: Japanese Patent Application Publication No. 2022-39101

### Non-Patent Documents

Non-Patent Document 1: Seiki Odawara ‘An Integrated Solution Offered by Sushi Sensor and GRANDSIGHT’ Yokogawa Technical Report, Vol. 61 No. 1 (2018): 21-24.
Non-Patent Document 2: Akirou Kitajima ‘“Sushi Sensor” for Industrial IoT Solution Realizes Sense-making’ Yokogawa Technical Report, Vol. 62 No. 2 (2019): 61-68.

### BRIEF DESCRIPTION OF THE DRAWINGS

FIG. 1 shows a configuration of a monitoring system 10 according to an embodiment of the present invention together with facilities 100a to 100c.

FIG. 2 shows a configuration of a monitoring apparatus 140 according to the embodiment of the present invention.

FIG. 3 shows an operational flow of the monitoring apparatus 140 according to the embodiment of the present invention.

FIG. 4 shows an example of history data recorded in a storage unit 142 according to the embodiment of the present invention.

FIG. 5 shows another example of the history data recorded in the storage unit 142 according to the embodiment of the present invention.

FIG. 6 shows a data set 1420 stored in the storage unit 142 according to the present embodiment.

FIG. 7 shows an operation example of a second identification executing unit 1432.

FIG. 8 shows a correspondence table 1421 stored in the storage unit 142 according to the present embodiment.

FIG. 9 shows a first example of a display screen 500 output by the monitoring apparatus 140 according to the embodiment of the present invention.

FIG. 10 shows a second example of the display screen 500 output by the monitoring apparatus 140 according to the present embodiment.

FIG. 11 shows an example of a detection condition designation screen output by the monitoring apparatus 140 according to the present embodiment.

FIG. 12 shows an example of a trend graph output by the monitoring apparatus 140 according to the present embodiment.

FIG. 13 shows an example of a detection condition change designation screen output by the monitoring apparatus 140 according to the present embodiment.

FIG. 14 shows an example of a learning designation screen output by the monitoring apparatus 140 according to the present embodiment.

FIG. 15 shows an example of a detection condition designation screen according to a modification of the present embodiment.

FIG. 16 shows a second identification executing unit 1432A according to the modification.

FIG. 17 shows an example of a computer 1200 in which a plurality of aspects of the present invention may be entirely or partially embodied.

### DESCRIPTION OF EXEMPLARY EMBODIMENTS

The present invention will be described below through embodiments of the invention, but the following embodiments do not limit the invention according to the claims. In addition, not all of the combinations of features described in the embodiments are essential to the solution of the invention.

### (Monitoring System 10)

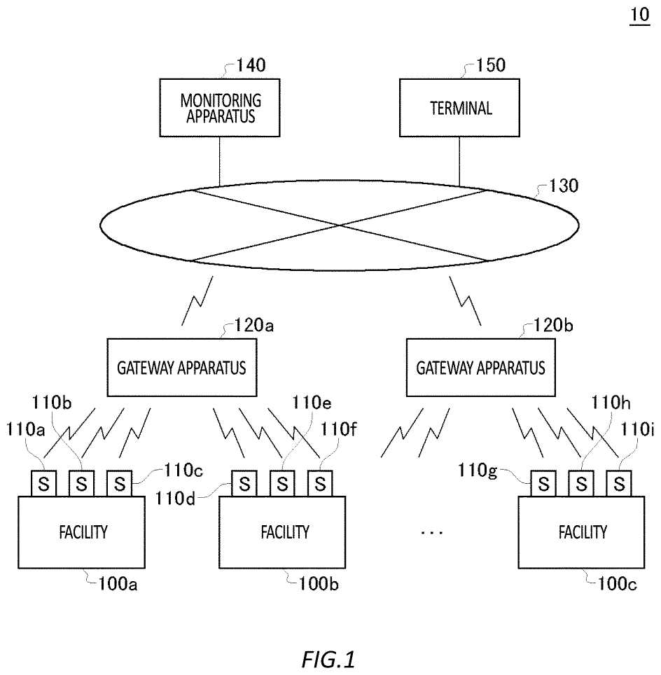

FIG. 1 shows a configuration of a monitoring system 10 according to the present embodiment together with a plurality of facilities 100a to 100c. Each of the facilities 100a to 100c (hereinafter, also referred to as a “facility 100”) is provided in a plant or the like. Such a plant may be, for example, an industrial plant such as a chemical or metal plant; a plant for managing and controlling a well site such as a gas field and an oil field and its surroundings; a plant for managing and controlling electrical power generation such as hydraulic, thermal, and nuclear power generation; a plant for managing and controlling energy harvesting such as solar photovoltaic and wind power generation; a plant for managing and controlling water supply and sewerage, a dam, or the like, etc. Moreover, each facility 100 may be provided in a building, various factories, transportation facilities, or the like. Such a facility 100 may have one or more process apparatuses, one or more electrical power generation apparatuses, and one or more other apparatuses.

Each facility 100 may have one or more pieces of field equipment. The field equipment may be, for example, sensor equipment such as a pressure meter, a flowmeter, and a temperature sensor; valve equipment such as a flow control valve and an on-off valve; actuator equipment such as a fan and a motor; imaging equipment such as a camera or a video for photographing a situation of a plant or the like and an object such as a facility; acoustic equipment such as a microphone or a speaker for collecting an abnormal noise from a plant, a facility, or the like, etc. or emitting a warning sound or the like; position detection equipment for outputting positional information of an apparatus provided in the facility 100; or another equipment.

Each facility 100 is provided with one or more sensors 110a to 100i (hereinafter, also referred to as a “sensor 110”) functioning as sensor equipment, imaging equipment, acoustic equipment, or the like for monitoring these states. Each sensor 110 may be sensor equipment incorporated in the facility 100, and may be retrofitted to the facility 100 or installed near the facility 100. Each sensor 110 may measure a physical quantity (for example, acceleration, speed, temperature, pressure, flow rate, vibration, or the like) related to the facility 100. Two or more sensors 110 may be incorporated in a sensor apparatus for measuring two or more types of physical quantities related to the facility 100. In the example of this figure, the sensors 110a to 110c are provided to monitor a state of the facility 100a, the sensors 110d to 110f are provided to monitor a state of the facility 100b, and the sensors 110g to 110i are provided to monitor a state of the facility 100c.

The monitoring system 10 includes one or more gateway apparatuses 120a and 120b, a monitoring apparatus 140, and a terminal 150. One or more gateway apparatuses 120a and 120b (hereinafter, also referred to as a “gateway apparatus 120”) are communicably connected to the plurality of sensors 110 and receive an output value from each sensor 110. In the present embodiment, each gateway apparatus 120 wirelessly communicates with at least one sensor 110 by using Low Power Wide Area (LPWA) such as LoRa as an example. Instead, each gateway apparatus 120 may communicate with the at least one sensor 110 by wire, and may communicate with the at least one sensor 110 by using a communication protocol defined by HART (registered trademark), BRAIN, FOUNDATION FIELDBUS (registered trademark), ISA100.11a, or the like. Each gateway apparatus 120 may be connected to two or more sensors 110 and collect output values of these two or more sensors 110. In the example of this figure, the gateway apparatus 120a is connected to the sensors 110a to 110f, and the gateway apparatus 120b is connected to the sensors 110g to 110i.

Each gateway apparatus 120 is connected to a network 130, and transmits an output of the sensor 110 assigned to each gateway apparatus 120 among the plurality of sensors 110 to the monitoring apparatus 140 via a network 130 which is a wide area network such as the Internet or WAN. In the example of this figure, each gateway apparatus 120 is connected to the network 130 via a wireless network such as a mobile phone line. Instead, each gateway apparatus 120 may be connected to the network 130 via a wired network such as ETHERNET (registered trademark).

The monitoring apparatus 140 is connected to one or more gateway apparatuses 120 via the network 130, and monitors one or more facilities 100 by using output values from the plurality of sensors 110. The monitoring apparatus 140 may be realized by a computer such as a PC (personal computer), a tablet computer, a smartphone, a workstation, a server computer, or a general-purpose computer, or may be realized by a computer system with a plurality of computers connected thereto. Such a computer system is also a computer in a broad sense. The monitoring apparatus 140 may be a dedicated computer designed for monitoring a facility, or may be a dedicated hardware realized by a dedicated circuit.

In the example of this figure, the monitoring apparatus 140 is a cloud computing system, and provides a facility monitoring environment through a service on a cloud computer to each of one or more customers who monitor a facility such as a plant. Instead, the monitoring apparatus 140 may be provided on the premises of a facility such as a specific plant, and be connected to each sensor 110 or each gateway apparatus 120 via a local area network to provide an on-premises facility monitoring environment. Moreover, the gateway apparatus 120 connected to the at least one sensor 110 may also function as the monitoring apparatus 140.

The terminal 150 is connected to the monitoring apparatus 140 via the network 130, and displays a screen for facility monitoring outputted by the monitoring apparatus 140. Moreover, the terminal 150 inputs an instruction from a monitoring person of a plant or the like provided with the one or more facilities 100, to transmit it to the monitoring apparatus 140. The terminal 150 may be arranged on the premises of a facility such as a plant, or may be arranged at a place away from a facility such as a plant. Note that the screen for facility monitoring may be displayed on an indicator or the like provided in the monitoring apparatus 140, and the instruction from the monitoring person may be inputted by using this indicator or the like.

### (Monitoring Apparatus 140)

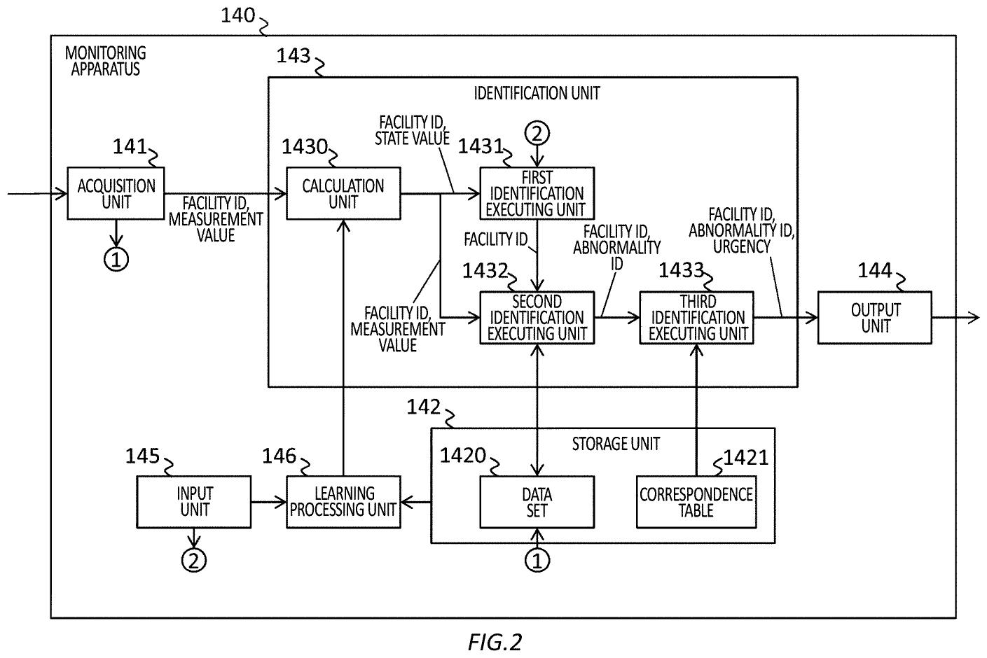

FIG. 2 shows a configuration of the monitoring apparatus 140 according to the present embodiment. The monitoring apparatus 140 includes an acquisition unit 141, a storage unit 142, an identification unit 143, an output unit 144, an input unit 145, and a learning processing unit 146.

### ((Acquisition Unit 141))

The acquisition unit 141 acquires measurement values corresponding to the outputs of the plurality of sensors 110 that monitor the states of the plurality of facilities 100. The measurement values corresponding to the outputs of the sensors 110 may be the output values itself of the sensors 110, or may be values obtained by performing predetermined computation on the output values. As an example, the measurement values may be scores for each principal component (that is, principal component scores or principal component values) obtained by performing principal component analysis on the output values from the plurality of sensors 110. The acquisition unit 141 may acquire, as the measurement value, the output value from the sensor 110, or may acquire the measurement value by performing predetermined computation on the output value from the sensor 110. The acquisition unit 141 may acquire the measurement value for each facility 100.

The acquisition unit 141 may be connected to one or more gateway apparatuses 120 via the network 130, and may acquire the output values of the plurality of sensors 110 from the gateway apparatus 120. The acquisition unit 141 may continuously acquire the most recent output value of each sensor 110, for example, at a predetermined cycle (every one second, every one minute, every one hour, or the like).

The acquisition unit 141 may supply the acquired measurement value to the storage unit 142 and a calculation unit 1430. In the present embodiment, as an example, the acquisition unit 141 may supply, to the storage unit 142 and the identification unit 143, the acquired measurement value in association with identification information (also referred to as a facility ID) of the facility 100 for which the measurement value is measured.

### ((Storage Unit 142))

The storage unit 142 is connected to the acquisition unit 141. The storage unit 142 is, for example, an external storage apparatus such as a hard disk apparatus, and sequentially stores the measurement value acquired by the acquisition unit 141 in association with timing information such as a time or date related to the measurement value, such as a measurement time of the sensor 110, an acquisition time of the gateway apparatus 120, or an acquisition time of the monitoring apparatus 140. Accordingly, the storage unit 142 may store history data of the measurement values of the plurality of sensors 110.

The storage unit 142 may store a plurality of data sets 1420 for at least one facility 100 (in the present embodiment, each facility 100 as an example). The plurality of data sets 1420 may include the data set 1420 at the time of abnormality occurrence. The data set 1420 at the time of abnormality occurrence may associate a measurement value in a case where abnormality has occurred in the past with an abnormality type of the abnormality, and may include, as an example, a measurement value corresponding to an output from the sensor 110 at the time of occurrence of the abnormality and identification information (also referred to as an abnormality ID) of the abnormality type. The data set 1420 at the time of abnormality occurrence may further include a name of the abnormality type. The plurality of data sets 1420 may further include the data set 1420 at a normal time. The data set 1420 at the normal time may include a measurement value corresponding to the output from the sensor 110 when no abnormality occurs and an abnormality ID indicating that there is no abnormality. However, the data set 1420 at the normal time may not be stored in the storage unit 142.

Note that the abnormality type of the abnormality occurring in the facility 100 may be common among the plurality of facilities 100 or may be different among the facilities 100. For example, in the facility 100 having a piping, abnormality of an abnormality type “piping rupture” may occur. In the facility 100 having an actuator, abnormality of an abnormality type “stopping due to breakage” may occur. In the facility 100 having a conveyor belt, abnormality of an abnormality type “breakage of conveyor belt” may occur. In the facility 100 having a transport roll, abnormality of an abnormality type “resonance of transport roll” may occur. In the facility 100 performing LAN communication, abnormality of an abnormality type “communication interruption” (for example, periodic communication interruption) may occur. In the facility 100 having a pump for liquid, abnormality of an abnormality type “dry running” (also referred to as run dry) may occur. In the facility 100 having a seal portion that is shaft-sealed (also referred to as shaft seal), abnormality of an abnormality type “leakage from the seal portion” may occur. In the facility 100 for containing liquid therein, abnormality of an abnormality type “cavitation” may occur. In the facility 100 having a hydraulic pump, abnormality of an abnormality type “decrease in performance due to oil degradation” (for example, flow rate decrease) may occur.

The storage unit 142 may store each of a plurality of abnormality types in association with the urgency of the abnormality in advance. In the present embodiment, as an example, the storage unit 142 may store the correspondence table 1421 in which the abnormality ID of each abnormality type that can occur in the facility 100, the name of the abnormality type, the property of the abnormality, and the urgency of the abnormality are associated with each other. The property of the abnormality may indicate how the abnormality occurs, and may indicate whether the abnormality is abnormality that cannot be predicted by prior inspection or monitoring (also referred to as sudden failure), abnormality that occurs intermittently and repeatedly (also referred to as intermittent failure), or abnormality that is caused by gradual deterioration of mechanical characteristics and can be predicted to some extent by prior inspection or monitoring (also referred to as deterioration failure). The urgency of the abnormality may indicate how quickly the operator is to respond to the abnormality, and may be any of “high”, “medium”, and “low” as an example.

### ((Identification Unit 143))

Based on the measurement value acquired by the acquisition unit 141, the identification unit 143 identifies which abnormality type of abnormality among a plurality of abnormality types determined in advance has occurred in which facility 100 among the plurality of facilities 100. The identification unit 143 may identify which facility 100 in the monitoring system 10 has experienced abnormality, and may identify which abnormality type of abnormality among the plurality of abnormality types determined in advance has occurred. The identification unit 143 may identify, for at least one facility 100, which abnormality type of abnormality among two or more abnormality types determined in advance has occurred and in the present embodiment, as an example, may identify, for each of the plurality of facilities 100, which abnormality type of abnormality has occurred. The identification unit 143 includes the calculation unit 1430, a first identification executing unit 1431, a second identification executing unit 1432, and a third identification executing unit 1433.

### (((Calculation Unit 1430)))

The calculation unit 1430 calculates a state value for each facility 100 based on the measurement value acquired by the acquisition unit 141. The calculation unit 1430 may calculate a state value corresponding to the measurement value supplied from the acquisition unit 141 for each facility 100. In the present embodiment, for each of the plurality of facilities 100, the calculation unit 1430 has a model that calculates a state value from the measurement value acquired for each facility 100, and calculates, for each facility 100, the state value from at least one measurement value by using the model. In this model, a diagnostic value indicating a result of diagnosing each facility 100, such as the soundness or normality degree of the facility 100 or the abnormality degree of the facility 100, may be calculated as the state value of the facility 100 based on the measurement value for the facility 100.

The calculation unit 1430 may store the state value calculated based on a measurement value at a certain time in the storage unit 142 in association with the measurement value. Moreover, the calculation unit 1430 may output at least one measurement value for the facility 100 as the state value of the facility 100, as it is. In this manner, each “state value” may be the above-described diagnostic value or the measurement value itself.

The calculation unit 1430 may supply the state value calculated for each facility 100 to the first identification executing unit 1431. In the present embodiment, for example, the calculation unit 1430 may supply the state value of each facility 100 to the first identification executing unit 1431 in association with the facility ID of the facility 100. The calculation unit 1430 may supply the measurement value for each facility 100 supplied from the acquisition unit 141 to the second identification executing unit 1432.

### (((First Identification Executing Unit 1431)))

The first identification executing unit 1431 identifies the facility 100 in which the abnormality has occurred, based on the state value of each facility 100. The first identification executing unit 1431 may identify, among the plurality of facilities 100, the facility 100 in which the state value has changed by a predetermined change width or change rate or more during a period of a predetermined time length, as the facility 100 in which the abnormality has occurred. The first identification executing unit 1431 may detect, among the respective state values of the facilities 100, a state value in which the state value has changed by the predetermined change width or change rate or more during the period of the predetermined time length, and may identify, as the facility 100 in which the abnormality has occurred, the facility 100 corresponding to the detected state value.

Here, the predetermined time length may be a length of a determination period for determining a change in the state value. The predetermined change width or change rate may be a determination threshold for determining whether or not to detect the state value. The first identification executing unit 1431 may detect, as the state value indicating occurrence of abnormality, a state value that has changed by the predetermined change width or change rate or more during the period of the predetermined time length. For example, the first identification executing unit 1431 may be set to detect a state value having dropped by 0.3 or more during two hours. For each of the plurality of state values, the first identification executing unit 1431 may determine whether or not the state value has changed by the predetermined change width or change rate or more between the most recent state value and a past state value a predetermined time length ago (for example, a state value two hours ago), and detect a state value for which it is determined that such a change has occurred. In the present embodiment, the first identification executing unit 1431 detects the state value based on whether or not the state value has changed by the predetermined change width or more. Instead, the first identification executing unit 1431 may detect the state value based on whether or not the state value has changed by the predetermined change rate or more. Note that the first identification executing unit 1431 may determine whether or not there is a change by the predetermined change width or change rate or more between the maximum value and the minimum value of the state value within the determination period.

The first identification executing unit 1431 may identify, as the facility 100 in which the abnormality has occurred, the facility 100 corresponding to the detected state value among the plurality of facilities 100. The first identification executing unit 1431 may supply the facility ID of the identified facility 100 to the second identification executing unit 1432.

### (((Second Identification Executing Unit 1432)))

The second identification executing unit 1432 identifies which abnormality type of the abnormality has occurred in the facility 100 identified by the first identification executing unit 1431. For the at least one facility 100 (in the present embodiment, each facility 100 as an example), the second identification executing unit 1432 may identify the abnormality type of the abnormality having occurred in the at least one facility 100 by cluster analysis using each data set 1420 stored in the storage unit 142. A specific method of the cluster analysis will be described later in detail. The second identification executing unit 1432 may supply, to the third identification executing unit 1433, the abnormality ID of the identified abnormality type and the facility ID of the facility 100 in which the abnormality has occurred.

### (((Third Identification Executing Unit 1433)))

The third identification executing unit 1433 identifies the urgency associated with the abnormality type identified by the second identification executing unit 1432. The third identification executing unit 1433 may identify the urgency associated with the identified abnormality type in the correspondence table 1421. The third identification executing unit 1433 may supply, to the output unit 144, information indicating the identified urgency and abnormality type and the facility ID of the facility 100 in which the abnormality has occurred. The information indicating the abnormality type may be the abnormality ID, or may be the name of the abnormality type, the property of the abnormality, or the like.

### ((Output Unit 144))

The output unit 144 outputs information indicating the facility 100 and the abnormality type identified by the identification unit 143. The output unit 144 may further output the urgency associated with the abnormality type identified by the identification unit 143. The output unit 144 may output, to the terminal 150, information indicating the identified facility 100, abnormality type, and the like, and may display the information via the terminal 150. The output unit 144 may display the identified facility 100, abnormality type, and urgency in descending order of urgency.

### ((Input Unit 145))

The input unit 145 inputs various instructions from the terminal 150 to the monitoring apparatus 140. For example, for at least one of the plurality of state values, the input unit 145 inputs an instruction to conduct the learning of the model used by the calculation unit 1430 to calculate the state value.

The input unit 145 may input designation of a length of the determination period (predetermined time length) and a determination threshold (at least one of the predetermined change width or change rate) for at least one of the plurality of state values. The input unit 145 sets, in the first identification executing unit 1431, the designated time length, change width, or the like as the time length, change width, or the like used by the first identification executing unit 1431 to detect the state value.

Moreover, the input unit 145 may input, for at least one of the plurality of state values, designation of a change period for changing a condition (for example, at least one of the predetermined time length or the predetermined change width or change rate) of the state value detection by the first identification executing unit 1431 and designation of a change value of the detection condition. In a case where a change instruction for the detection condition by the monitoring person or the like is input via the terminal 150, for the state value in which the change period is designated, the first identification executing unit 1431 changes at least one of the predetermined time length or the predetermined change width or change rate to the designated change value and detects the state value during the change period.

Moreover, for at least one of the plurality of state values, the input unit 145 may input designation of an exclusion period to be excluded from detection by the first identification executing unit 1431. In a case where the designation of the exclusion period by the monitoring person or the like is input via the terminal 150, the first identification executing unit 1431 does not detect the state value in which the exclusion period is designated, during the exclusion period.

### ((Learning Processing Unit 146))

The learning processing unit 146 is connected to the storage unit 142 and the calculation unit 1430. In response to an instruction to conduct the learning of the model of the calculation unit 1430 being input from the terminal 150 via the input unit 145, the learning processing unit 146 performs processing of generating a model by learning based on the history data of the plurality of measurement values stored in the storage unit 142. The learning processing unit 146 may perform learning processing on the model used for calculation of any state value among the state values for the respective facilities 100. Then, the learning processing unit 146 provides the learned model to the calculation unit 1430.

According to the monitoring apparatus 140 described above, which abnormality type of abnormality has occurred in which facility 100 is identified based on the acquired measurement value, and information indicating the identified facility 100 and abnormality type is output. Therefore, unlike a case where the operator determines the facility 100 in which the abnormality has occurred and the abnormality type, it is possible to accurately and early identify and report the facility 100 in which the abnormality has occurred and the abnormality type.

Moreover, for at least one facility 100, it is identified which abnormality type of abnormality among two or more abnormality types determined in advance has occurred, and thus, even in a case where two or more abnormality types of abnormality may occur in one facility 100, it is possible to accurately identify and report which abnormality type of abnormality has occurred.

Moreover, the state value for each facility 100 is calculated based on the acquired measurement value, the facility 100 in which the abnormality has occurred is identified based on the state value of each facility 100, and which abnormality type of abnormality has occurred in the identified facility 100 is identified. Therefore, it is possible to prevent that the abnormality type is identified for the facility 100 in which no abnormality has occurred.

Moreover, among the plurality of facilities 100, the facility 100 in which the state value has changed by the predetermined change width or change rate or more during the period of the predetermined time length is identified as the facility 100 in which the abnormality has occurred. Therefore, it is possible to prioritize identifying the facility 100 in which the state value of higher importance has changed, as the facility 100 in which the abnormality has occurred. Therefore, unlike a case where the facility 100 in which a minor change in the state value has occurred is identified, it is possible to accelerate the response to the abnormality of the facility 100 to increase the operation rate of the plant or the like, and reduce the occurrence of abnormality.

Moreover, each of the plurality of abnormality types is stored in association with the urgency of the abnormality in advance, and the urgency associated with the identified abnormality type is further output. Therefore, unlike a case where the operator determines the urgency, it is possible to report an appropriate urgency. Therefore, it is possible to accelerate the response to the abnormality of the facility 100 to increase the operation rate of the plant or the like, and reduce the occurrence of abnormality.

Moreover, for at least one facility 100, the abnormality type of the abnormality having occurred in the facility 100 is identified by cluster analysis using the data set 1420 in which a measurement value in a case where abnormality has occurred in the past is associated with an abnormality type of the abnormality. Therefore, the abnormality type can be identified more accurately.

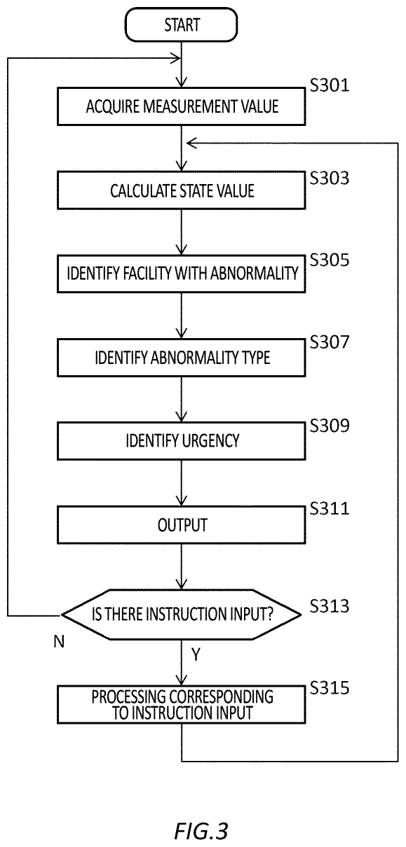

FIG. 3 shows an operational flow of the monitoring apparatus 140 according to the present embodiment. The monitoring apparatus 140 supports monitoring of each facility 100 by performing the processing of steps S301 to S313. Note that, in this figure, an operation in a case where abnormality has occurred in any facility 100 will be described.

In step S301, the acquisition unit 141 acquires measurement values corresponding to the outputs of the plurality of sensors 110. The acquisition unit 141 may acquire, as the measurement value, the most recent output value from the sensor 110, or may acquire, as the measurement value, a computation result obtained by performing predetermined computation on the output value. The acquisition unit 141 may store, in the storage unit 142, the acquired measurement value as a new data set 1420. The abnormality type included in the data set 1420 may be stored in step S311 described later.

In step S303, each of the plurality of facilities 100, the calculation unit 1430 calculates the state value of the facility 100 by using the model associated with the facility 100. In the present embodiment, as an example, the model associated with the facility 100 is input with one or two or more measurement values at a certain time point (for example, a current time point or the most recent time point) of each sensor 110 assigned to the facility 100, and defines a calculation method for calculating a diagnostic value at the certain time point (for example, the current time point or the most recent time point) of the facility 100 from these measurement values. Using such a model, the calculation unit 1430 may calculate the state value from the measurement value acquired in step S301 (also referred to as the most recent measurement value). Note that, in a case where any measurement value is designated to be output as the state value, the calculation unit 1430 may output, as the state value, the measurement value as it is.

In step S305, the first identification executing unit 1431 identifies which facility 100 among the plurality of facilities 100 has experienced abnormality. The first identification executing unit 1431 may perform identification based on the most recent measurement value, and in the present embodiment, as an example, may perform identification based on the state value calculated for each facility 100 by the calculation unit 1430 using the most recent measurement value.

The first identification executing unit 1431 may detect, among the plurality of state values calculated by the calculation unit 1430, a state value which has changed by the predetermined change width or change rate or more during the period of the predetermined time length. The first identification executing unit 1431 may identify, as the facility 100 in which the abnormality has occurred, the facility 100 corresponding to the detected state value among the plurality of facilities 100.

In step S307, the second identification executing unit 1432 identifies which abnormality type of abnormality has occurred in the facility 100 identified in step S303 (also referred to as an abnormal facility 100). The second identification executing unit 1432 may perform identification based on the most recent measurement value.

For example, for the abnormal facility 100, the second identification executing unit 1432 may identify the abnormality type of the abnormality having occurred in the abnormal facility 100 by cluster analysis using each data set 1420 stored in the storage unit 142. The second identification executing unit 1432 may read the data set 1420 from the storage unit 142 and perform cluster analysis.

Here, in each data set 1420 in the storage unit 142 according to the present embodiment, the measurement value is associated with the abnormality ID of the abnormality type. The second identification executing unit 1432 may read each data set 1420 for the abnormal facility 100 from the storage unit 142, perform cluster analysis on a set of measurement values each associated with the abnormality ID, and may classify the measurement values into a plurality of clusters. The second identification executing unit 1432 may perform cluster analysis by a conventionally known method, may perform cluster analysis by the k-means method with the number of abnormality IDs included in the data set 1420 for the abnormal facility 100 as the number of clusters, or may perform cluster analysis by another method without determining the number of clusters. The measurement values included in each cluster may share a common abnormality ID associated in the data set 1420. The second identification executing unit 1432 may associate the abnormality ID, which is associated with each measurement value included in the cluster in the data set 1420, with the center point of each cluster. The second identification executing unit 1432 may identify a center point closest to the most recent measurement value of the abnormal facility 100 among the center points of the clusters and identify the abnormality ID associated with the center point as the abnormality ID of the abnormality having occurred. Instead, the second identification executing unit 1432 may identify a measurement value closest to the most recent measurement value of the abnormal facility 100 among the measurement values of the data sets 1420 for the abnormal facility 100, and identify the abnormality ID associated with measurement value in the data set 1420 as the abnormality ID of the abnormality having occurred.

Note that the second identification executing unit 1432 may also perform cluster analysis, including the most recent measurement value of the abnormal facility 100. In this case, the second identification executing unit 1432 may read each data set 1420 for the abnormal facility 100 from the storage unit 142, and perform cluster analysis on a set of each measurement value associated with the abnormality ID (that is, the measurement value of the data set 1420) and the most recent measurement value. The second identification executing unit 1432 may identify, as the abnormality ID of the abnormality having occurred, the abnormality ID associated in the data set 1420 with another measurement value included in the same cluster as that of the most recent measurement value.

In step S309, the third identification executing unit 1433 identifies the urgency associated with the identified abnormality type in the correspondence table 1421. The third identification executing unit 1433 may further identify the name or the like of the abnormality type associated with the identified abnormality type in the correspondence table 1421.

In step S311, the output unit 144 outputs information indicating the facility 100, the abnormality type, and the urgency identified in steps S305, S307, and S309. The output unit 144 may output information further including the most recent measurement value or state value. The output unit 144 may cause the terminal 150 to display the information. The output unit 144 may store the abnormality ID of the identified abnormality type and the name of the abnormality type included in the data set 1420 stored in the storage unit 142 in step S301.

In step S313, the input unit 145 determines whether there is an instruction input from the terminal 150. If it is determined that there is no instruction input (step S313; No), the processing may proceed to step S301 described above. Accordingly, the monitoring apparatus 140 repeats the processing from S301 for the measurement value at the next time point. If it is determined that there is an instruction input (step S313; Yes), the processing may proceed to step S315.

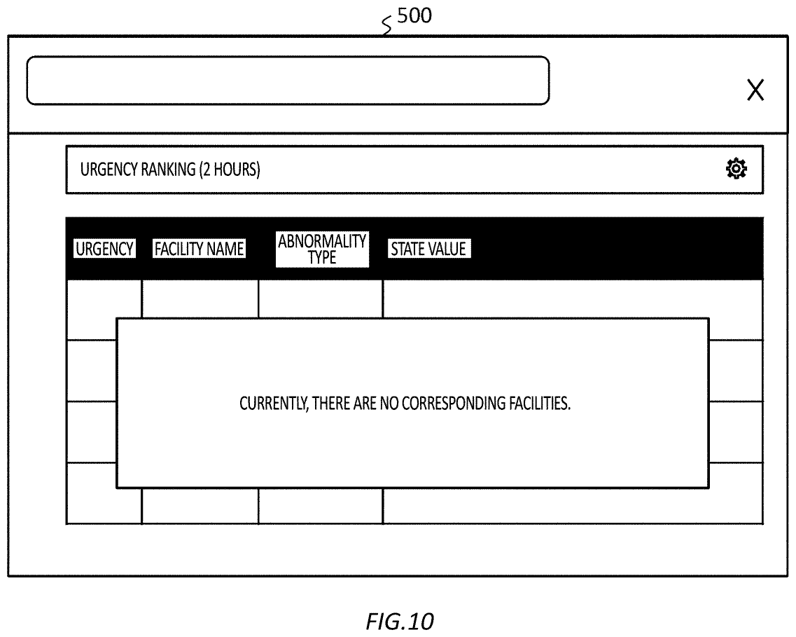

In step S315, the input unit 145 or the like perform processing corresponding to the instruction input. For example, in a case where an instruction for the length of the determination period (predetermined time length) and the determination threshold (at least one of the predetermined change width or change rate) is input for at least one of the state values for each facility 100, the input unit 145 may set, in the first identification executing unit 1431, the instructed time length, change width, or the like as the time length, change width, or the like used by the first identification executing unit 1431 to detect the state value. In a case where an instruction for the change period for changing the condition (for example, at least one of the predetermined time length or the predetermined change width or change rate) of the state value detection by the first identification executing unit 1431 and an instruction for the change value of the detection condition are input for at least one of the state values for each facility 100, the first identification executing unit 1431 may change, for the designated state value, at least one of the predetermined time length or the predetermined change width or change rate to the instructed change value during the instructed change period. In a case where an instruction for the exclusion period to be excluded from detection by the first identification executing unit 1431 is input for at least one of the state values for each facility 100, the first identification executing unit 1431 may set such that the state value for which the exclusion period is designated is not detected during the exclusion period. When the processing in step S315 ends, the processing may proceed to step S303 described above, and the processing in and after step S303 may be performed again using a set condition or the like. Specific processing in step S315 will be described later in relation to FIGS. 10 to 14.

Note that in the above-described operation, the second identification executing unit 1432 identifies the abnormality type of the abnormality having occurred in the abnormal facility 100 by cluster analysis using the data set stored in the storage unit 142, and thus, identifies the abnormality type included in any data set 1420. However, the second identification executing unit 1432 may identify a new abnormality type not included in any data set 1420. As an example, the second identification executing unit 1432 may perform cluster analysis on the measurement value of each data set 1420 to calculate the measurement value indicating the center point for each cluster, and when a distance between the most recent measurement value and the measurement value of each center point is greater than a reference distance, identify that abnormality of a new abnormality type has occurred. In this case, the output unit 144 may output information indicating the facility 100 identified in step S305 and the occurrence of the abnormality of the new abnormality type.

Moreover, although it has been described in step S315 that the length of the determination period, the determination threshold, or the like is changed according to the instruction input, other processing may be performed. For example, in a case where the correction instruction for the abnormality type output in step S311 is input to the input unit 145 in step S313, the input unit 145 may correct the abnormality ID and the name of the abnormality type stored in the data set 1420 in step S311 according to the correction instruction. As an example, the abnormality ID and the name stored in the storage unit 142 may be changed to the abnormality ID and the name of another data set 1420 already stored in the storage unit 142, or may be changed to a new abnormality ID and a new name not stored in the storage unit 142.

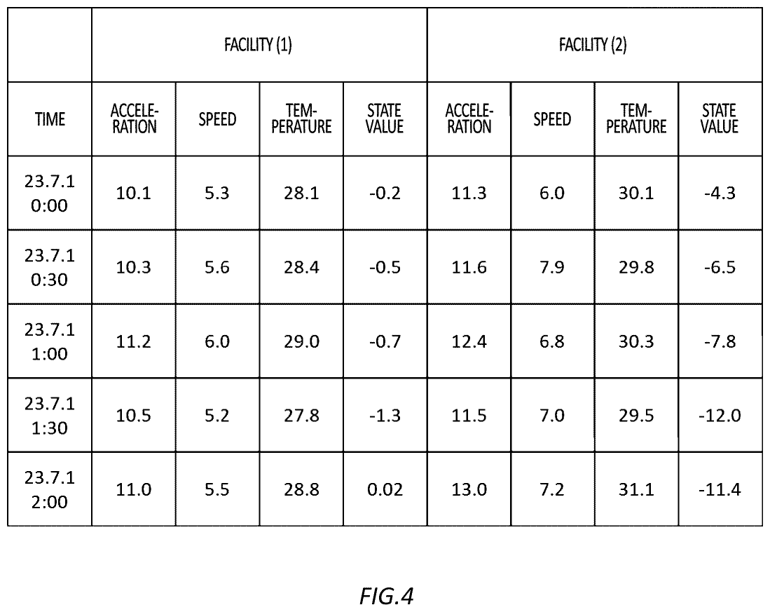

FIG. 4 shows an example of history data stored in the storage unit 142 according to the present embodiment. The storage unit 142 stores history data including measurement values corresponding to output values output from the plurality of sensors 110 at a plurality of times such as predetermined time intervals and a plurality of state values calculated for the plurality of facilities 100.

The history data shown in this figure has: a time field for recording a time; and a plurality of facility fields for recording a measurement value and a state value for each of the plurality of facilities 100. Each facility field includes at least one measurement value field for recording a measurement value of the corresponding facility 100 and a state value field for recording a state value of the corresponding facility 100. Here, the time recorded in the time field may be a time correlated with the measurement value or the state value. Note that, in this figure, measurement values of acceleration, speed, and temperature are stored for each of the facility 100 of the “facility (1)” and the facility 100 of the “facility (2)”.

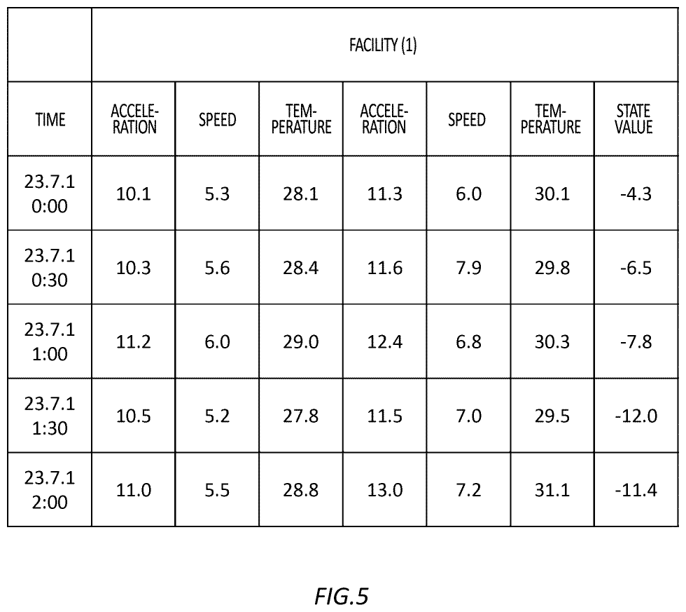

FIG. 5 shows another example of the history data recorded in the storage unit 142 according to the present embodiment. In this figure, acceleration, speed, and temperature each corresponding to output values from two sensors 110 are stored for the facility 100 of the “facility (1)”.

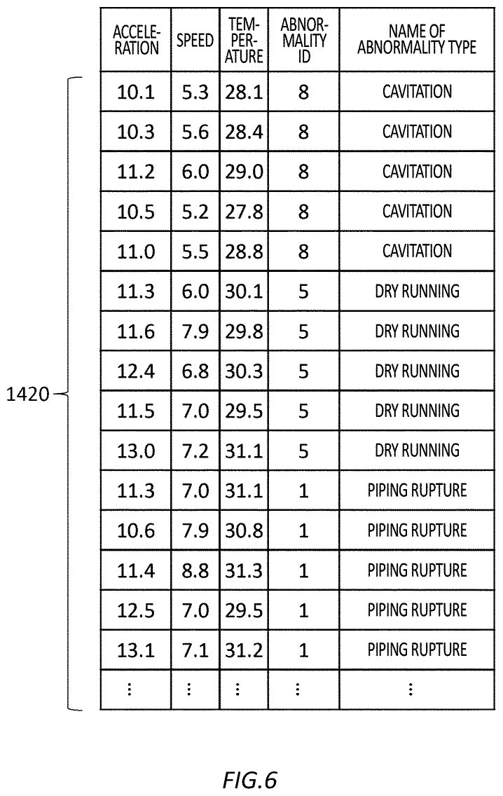

FIG. 6 shows the data set 1420 stored in the storage unit 142 according to the present embodiment. The storage unit 142 according to the present embodiment may store the data set 1420 at the time of abnormality occurrence. Each data set 1420 includes a field for recording a measurement value, a field for recording an abnormality ID, and a field for recording a name of an abnormality type.

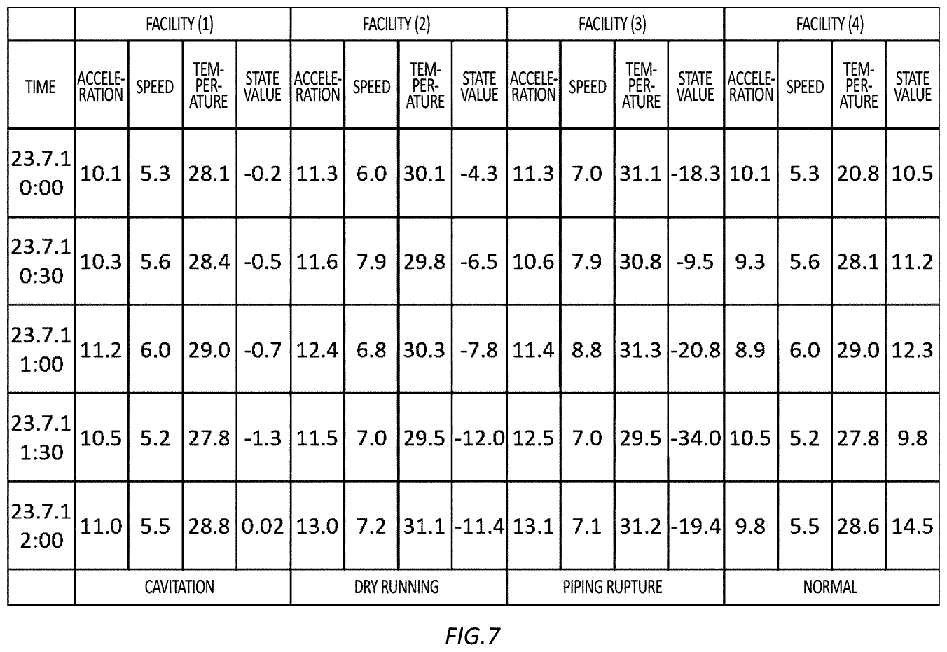

FIG. 7 shows an operation example by the second identification executing unit 1432. The second identification executing unit 1432 may identify which abnormality type of abnormality has occurred in each facility 100. In the example of this figure, the second identification executing unit 1432 shows a case where based on the measurement value at each time, the abnormality of the abnormality type “cavitation” is identified to have occurred in the facility (1), the abnormality of the abnormality type “dry running” is identified to have occurred in the facility (2), the abnormality of the abnormality type “piping rupture” is identified to have occurred in the facility (3), and no abnormality is identified to have occurred in the facility (4).

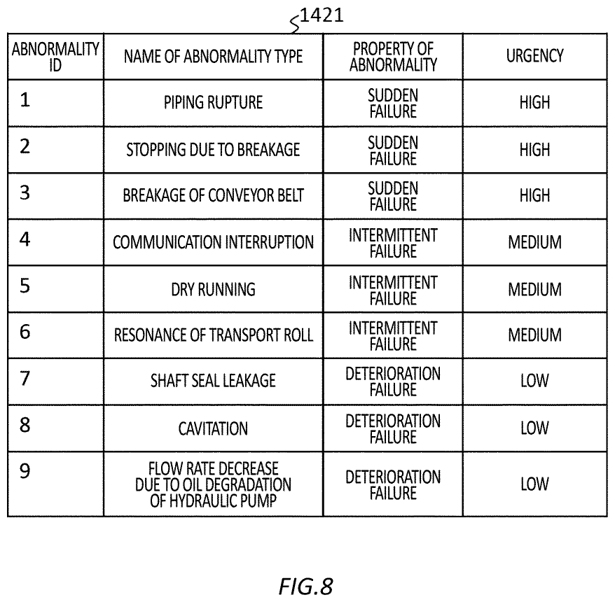

FIG. 8 shows the correspondence table 1421 stored in the storage unit 142 according to the present embodiment. The correspondence table 1421 may store an abnormality ID, a name of an abnormality type, a type of the abnormality, and urgency of the abnormality in association with each other for each of the plurality of abnormality types.

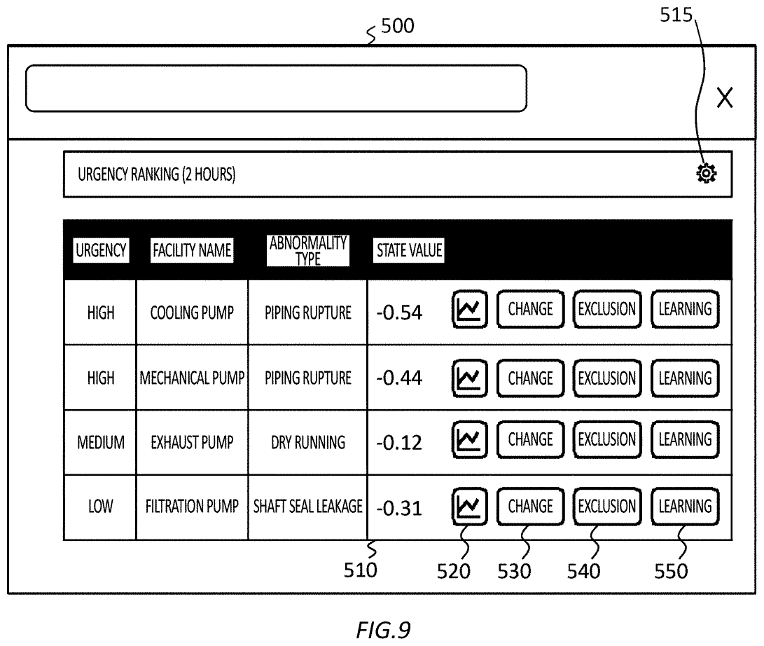

FIG. 9 shows a first example of the display screen 500 output by the monitoring apparatus 140 according to the present embodiment. The output unit 144 performs display processing for displaying the identification result by the identification unit 143.

The display screen 500 includes a list 510 and a setting button 515. The list 510 displays each entry corresponding to each of at least one state value in an order sorted according to urgency. The list 510 displays, for each entry, urgency of abnormality, a facility name, a name of an abnormality type, and a current state value.

In the present embodiment, the list 510 displays each entry in descending order of urgency. The state value may be an index indicating the soundness of the corresponding facility 100. In the example of this figure, abnormality of the abnormality type “piping rupture” with urgency of “high” occurs in the “cooling pump” having a state value of −0.54 and the “mechanical pump” having a state value of −0.44. Accordingly, the monitoring apparatus 140 can prioritize displaying, on the terminal 150, the facility 100 in which abnormality with high urgency has occurred, thereby enabling quicker measures such as inspection.

Note that the output unit 144 may change a display format according to the level of the urgency. For example, for higher urgency, the output unit 144 may emphasize the urgency by changing character color or background color to a more conspicuous color such as red, enlarging characters, making characters bold, adding an auxiliary line such as underline, or changing another display format.

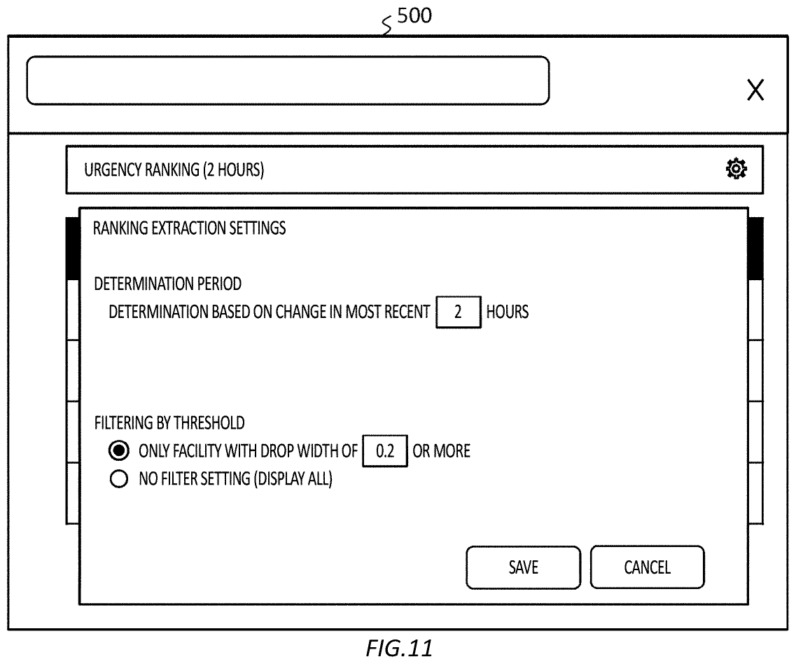

The setting button 515 is a button for giving an instruction to display a detection condition designation screen for designating at least one of the length of the determination period (two hours in this figure) or the determination threshold used by the first identification executing unit 1431 to detect the state value. The detection condition designation screen will be described later with reference to FIG. 11.

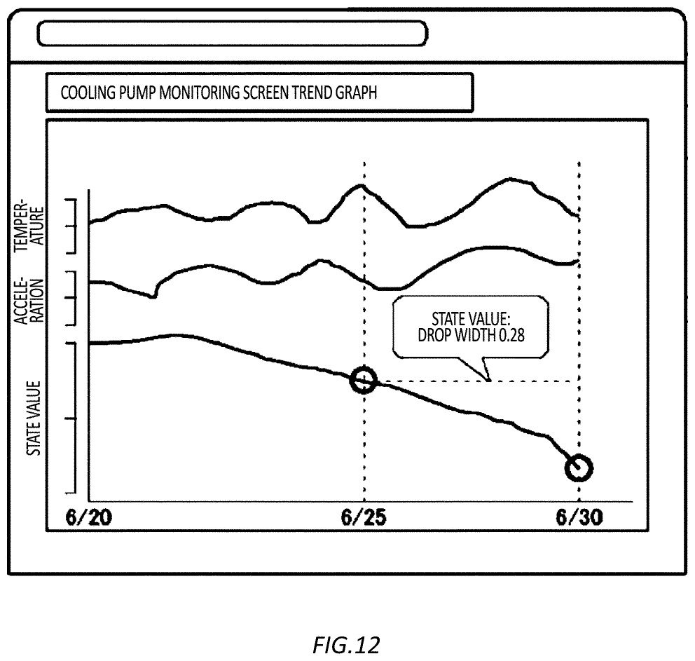

Moreover, the output unit 144 may perform processing of displaying a graph display button 520 in association with each of at least one state value sorted in the display screen 500. The graph display button 520 is a button for instructing to display a trend graph related to each state value. The display of the trend graph will be described later with reference to FIG. 12.

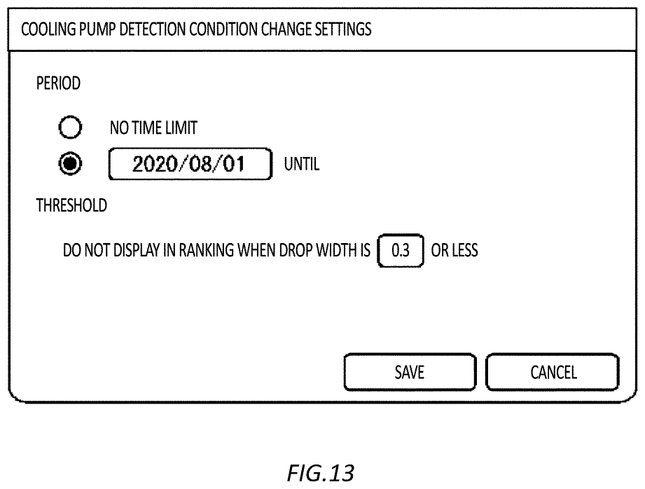

The output unit 144 may perform processing of displaying a change button 530 in association with each of at least one state value sorted in the display screen 500. The change button 530 is a button for giving an instruction to display a detection condition change designation screen for changing the detection condition of the first identification executing unit 1431 for the corresponding state value during the designated change period. The detection condition change designation screen will be described later with reference to FIG. 13.

The output unit 144 may perform processing of displaying an exclusion button 540 in association with each of at least one state value sorted in the display screen 500. The exclusion button 540 is a button for giving an instruction to display a screen for excluding the corresponding state value from the detection by the first identification executing unit 1431 during the designated exclusion period. This screen will be described later in relation to FIG. 13.

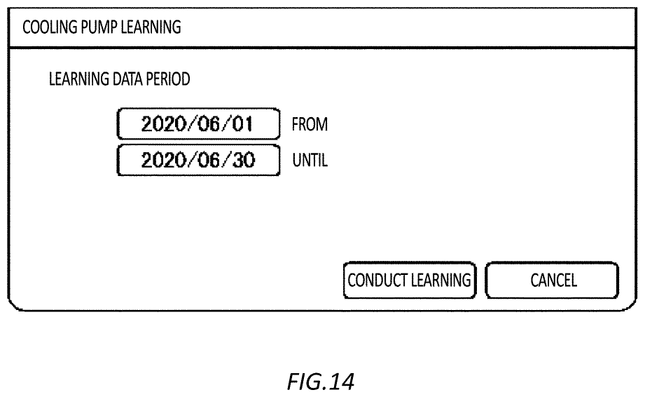

The output unit 144 may perform processing of displaying a learning button 550 in association with each of sorted state values. The learning button 550 is a button for instructing learning of a model that calculates each state value. In the present embodiment, the learning button 550 is for instructing to display a learning designation screen for performing designation regarding the learning of the model that calculates each state value. The learning designation screen will be described later in relation to FIG. 14.

Note that the output unit 144 may display the display screen 500 as one of display components such as a dashboard, a window, or a sub-window included in a monitoring screen. Accordingly, as an example, the output unit 144 can cause the monitoring screen to display a plurality of display screens 500 having different parameters such as a time length or a change width used to detect the state value.

FIG. 10 shows a second example of the display screen 500 output by the monitoring apparatus 140 according to the present embodiment. As shown in this figure, when none of the plurality of state values is detected by the first identification executing unit 1431, the output unit 144 performs processing of displaying that there is no detected state value, that is, there is no abnormal facility 100. In the example of this figure, when none of the state values of the facilities 100 is detected, the output unit 144 causes the terminal 150 to display that none of the facilities 100 corresponds to the detection condition. Accordingly, the output unit 144 explicitly indicates that there is no facility 100 to be noted, and can reduce the management load of a plant or the like during normal running. Note that, as the display indicating that there is no detected state value, for example, the output unit 144 may explicitly indicate information indicating that there is no detected state value by performing display such as “0 case hit” indicating that the number of detected cases is 0, or the like, may implicitly display that there is no detected state value by, for example, displaying a list of no entry and only a title row, or may indicate that there is no detected state value by another method.

FIG. 11 shows an example of the detection condition designation screen output by the monitoring apparatus 140 according to the present embodiment. The output unit 144 performs processing of displaying the detection condition designation screen in this figure in response to pressing of the setting button 515 (see FIG. 9) in the display screen 500. The detection condition designation screen is a screen for inputting designation of the length of the determination period (predetermined time length) and the determination threshold (predetermined change width or change rate) used by the first identification executing unit 1431 to detect the state value.

The detection condition designation screen accepts the length of the determination period in units of time as an example by using “determination period” field. Instead, the detection condition designation screen may accept the length of the determination period by using another unit such as second, minute, day, week, or month.

Moreover, the detection condition designation screen accepts the determination threshold used during the determination period by using “filter by threshold” field. The blank of “only facility with drop width of (blank) or more” in “filter by threshold” field accepts an input of the determination threshold of the drop width of the state value. For example, as shown in this figure, in a case where “filter by threshold” field is designated as “only facility with drop width of 0.2 or more”, the first identification executing unit 1431 detects the state value having dropped by 0.2 or more during the determination period (for example, two hours) designated in “determination period” field. Note that “no filter (display all)” in “filter by threshold” field is designated to display all the state values. When this item is selected, the first identification executing unit 1431 detects all the state values.

Moreover, the detection condition designation screen may include a save button for saving the designation and setting the designation in the first identification executing unit 1431, and a cancel button for canceling the designation. When the designation of the detection condition is input via the detection condition designation screen in step S313 of FIG. 3, the detection condition input unit 145 sets the designated detection condition in the first identification executing unit 1431 in step S315. Accordingly, the first identification executing unit 1431 can detect the state value by using the detection condition input via the detection condition designation screen in response to the re-execution of step S305. Note that the output unit 144 may display a screen for designating only one of the length of the determination period or the determination threshold as the detection condition designation screen, and the input unit 145 may set the designated length of determination period or the designated determination threshold in the first identification executing unit 1431.

FIG. 12 shows an example of a trend graph output by the monitoring apparatus 140 according to the present embodiment. In response to pressing of the graph display button 520 (see FIG. 9) associated with the state value of a certain facility 100 in the display screen 500, the output unit 144 performs processing of displaying a trend graph related to the state value of the facility 100. Specifically, the output unit 144 outputs, on the display screen, an axis, an axis title, an axis scale, or the like for each of a horizontal axis and a vertical axis of the trend graph. Moreover, the output unit 144 reads, from the storage unit 142, the state value to be displayed at each time within the display period of the trend graph and plots the state value on the trend graph.

The trend graph shows a temporal change of the corresponding state value. In this figure, the horizontal axis represents time, and the vertical axis represents a state value. The output unit 144 may cause the terminal 150 to display, in addition to the graph itself of the temporal change of the state value, additional information such as an auxiliary line or an annotation with which the change width or change rate of the state value can be visually confirmed. In the trend graph of this example, points on the graph corresponding to the state values at the start and end of the determination period in which it is determined that the detection condition is satisfied are emphasized by surrounding the points with circles. Moreover, the trend graph of this example includes broken lines in a vertical axis direction indicating the start and end timings of the determination period in which it is determined that the detection condition is satisfied. Moreover, the trend graph of this example includes a broken line a horizontal axis direction indicating the level of the state value at the start of the determination period in which it is determined that the detection condition is satisfied. Moreover, the trend graph of this example numerically shows a drop width of the state value by using a balloon or the like.

Moreover, in addition to the graph of the state value of the target facility 100, the output unit 144 may perform processing of displaying a graph of measurement values of one or two or more sensors 110 assigned to the facility 100. Specifically, the output unit 144 reads, from the storage unit 142, the measurement value to be displayed at each time within the display period of the trend graph and plots the measurement value on the trend graph. The trend graph of this example shows, in addition to a transition of the state value of the facility 100, transitions of measurement values of a temperature and acceleration regarding the facility 100 during the same period.

According to the output unit 144 described above, the trend graph of the designated state value of the facility 100 among the state values of the facility 100 detected by the first identification executing unit 1431 can be displayed. Accordingly, the output unit 144 can more quickly display the change in the important state value detected by the first identification executing unit 1431, and can resolve the abnormality of a plant or the like at an early stage.

FIG. 13 shows an example of the detection condition change designation screen output by the monitoring apparatus 140 according to the present embodiment. In response to pressing of the change button 530 (see FIG. 9) associated with a certain state value in the display screen 500, the output unit 144 performs processing of displaying the detection condition change designation screen for designating a change with respect to the detection condition of the state value.

The detection condition change designation screen is a screen for inputting designation of the change period for changing the detection condition and designation of at least one change value of the length of the determination period or the determination threshold for a target state value. The detection condition change designation screen accepts the designation of a change period by using “period” field. In the example of this figure, when receiving a selection of “no time limit”, the change period input unit 145 inputs designation of an indefinite change period starting from the current time point. Moreover, when receiving a selection of “until (blank)”, the change period input unit 145 inputs designation of a change period from the current time point to a date and time inputted into (blank). Instead, the detection condition change designation screen may allow the input of the date and time of the start and end of the change period, or may allow the designation of a plurality of change periods.

Moreover, the detection condition change designation screen accepts the designation of the determination threshold by using “threshold” field. In the example of this figure, when receiving an input into (blank) of “do not display in ranking when drop width is (blank) or less”, the change period input unit 145 inputs a value inputted into (blank) as the determination threshold of the drop width of the state value. In response to inputs into “period” field and “threshold” field, the change period input unit 145 sets, for the corresponding state value, the determination threshold to a designated value during the designated change period. This determination threshold is a threshold used for the state value detection (or non-detection) by the first identification executing unit 1431. Accordingly, for the state value for which the change period is designated, the first identification executing unit 1431 can detect the state value by changing the determination threshold to the designated change value during the change period.

Note that, the detection condition change designation screen may accept the designation of the change period and the designation of the length of the determination period during the change period. In this case, for the state value for which the change period is designated, the first identification executing unit 1431 can detect the state value by changing the length of the determination period to the designated change value during the change period.

Moreover, in response to pressing of the exclusion button 540 (see FIG. 9) associated with a certain state value in the display screen 500, the output unit 144 performs processing of displaying an exclusion period designation screen for designating a period during which the state value is excluded from detection. The exclusion period designation screen has “period” field similar to “period” field of the detection condition change designation screen, but may adopt a screen configuration not having “threshold” field. In the exclusion period designation screen, “period” field is used to accept the designation of the exclusion period. When receiving the input in the “period” field, the exclusion period input unit 145 sets the first identification executing unit 1431 to exclude the corresponding state value from the detection during the designated exclusion period. Accordingly, the first identification executing unit 1431 can prevent the state value in which the exclusion period is designated from being detected during the exclusion period.

For the target state value, the monitoring apparatus 140 can change at least one of the length of the determination period or the determination threshold during the change period, so that in a case where the cause of drop or the like in the state value is already known, the state value is not detected, for example, even when the state value drops within the range assumed by the cause. Accordingly, the monitoring apparatus 140 can cause the terminal 150 to prioritize displaying another state value detected by the first identification executing unit 1431, thereby prioritizing investigating the cause of an important change in the another state value. Moreover, the monitoring apparatus 140 does not detect any change in the target state value during the exclusion period, so that, for example, in a case where the abnormality of the facility 100 or the sensor 110 has already been identified, it is possible to prioritize displaying another state value on the terminal 150.

FIG. 14 shows an example of a learning designation screen output by the monitoring apparatus 140 according to the present embodiment. In response to pressing of the learning button 550 (see FIG. 9) associated with a certain state value in the display screen 500, the output unit 144 performs processing of displaying the learning designation screen for performing designation regarding the learning of the model that calculates the state value. Then, the learning processing unit 146 performs, in response to the learning button 550 being pressed, processing to generate the model by learning after receiving the designation regarding the learning of the model.

The learning designation screen according to the present embodiment inputs designation of a period of learning data used for the learning of the model that calculates the target state value. In the example of this figure, the learning designation screen accepts designation of a start date and an end date of the period of the learning data. Instead, the learning designation screen may allow a plurality of periods of the learning data to be inputted. Moreover, the learning designation screen may allow a hyperparameter (a parameter set prior to learning such as the number of layers in a neural network, the number of neurons in each layer, or the like) such as a set value that does not change due to the learning in the model, to be inputted.

The learning designation screen may have “conduct learning” button for instructing to start the learning of the model by using the designation regarding the learning. When “conduct learning” button is pressed, the input unit 145 inputs the period of the learning data designated on the learning designation screen to provide the period to the learning processing unit 146, and instructs the learning processing unit 146 to start the learning.

When the start of the learning is instructed, the learning processing unit 146 acquires, from the storage unit 142, the measurement value of at least one sensor 110 used to calculate the target state value at each timing in the period designated by the input unit 145 and sets the measurement value as learning data. Here, in a case where the target state value is, for example, the state value of the facility 100a, the learning processing unit 146 includes, in the learning data, measurement values from the sensors 110a to 110c for monitoring the state of the target facility 100a. In the present embodiment, the learning processing unit 146 uses, for each timing during the period of the learning data, a set of measurement values from the sensors 110a to 110c as one sample of the learning data.

In the present embodiment, the learning processing unit 146 generates, by learning, a model by unsupervised learning. As an example, by statistical learning using at least one measurement value included in the learning data, the learning processing unit 146 may perform processing of generating a model by learning. As an example of the statistical learning, the learning processing unit 146 may use the learning data to calculate probability distribution of a sample in a multidimensional space (a space whose dimension is the number of measurement values included in each sample), to give it to the model. Here, since abnormality is rarely generated in a plant or the like, and it is operating almost properly during the period of the learning data, it can be estimated that the farther a new set of measurement values is deviated from the probability distribution, the more likely it is to be abnormal. Using this probability distribution allows the model to calculate, when a new set of measurement values is inputted, how far the new set of measurement values is deviated from the probability distribution. As an example, such a model outputs, as a state value, a value that drops as it is deviated from the probability distribution. The above-described model may output the state value obtained by normalizing the degree of deviation from the probability distribution by the standard deviation of the probability distribution.

Instead of the above, the learning processing unit 146 may conduct the learning of the model by supervised learning. In this case, each sample in the learning data is labeled as normal, abnormal, or the like. For example, the input unit 145 may input the designation on the learning designation screen of a normal period in which the target facility 100 is normal and an abnormal period in which the target facility is abnormal, and add a label corresponding to the designation to each sample in the learning data.

The model may be, as an example, a neural network, SVM, or the like. The input unit 145 updates the parameters of the model so as to reduce an error between the output of the model in a case where each sample in the learning data is input to the model, and the label. For example, in the case of using a neural network, the input unit 145 adjusts a weight between neurons of the neural network, a bias of each neuron, or the like with a method such as back propagation by using an error between the output value, which is output from the neural network in response to the input of each sample, and the label.

For a certain state value in the display screen 500, in response to pressing of the learning button 550, the designation of a period of learning data is input and a model is generated by learning, whereby the monitoring apparatus 140 can generate a model with higher accuracy by using a measurement value in a period suitable for calculating each state value. Moreover, in a case where the state value output by the learned model is not appropriate, in response to pressing of the learning button 550, the monitoring apparatus 140 can change the range of the measurement value to be used as the learning data among the measurement values stored in the storage unit 142, and update the model by relearning.

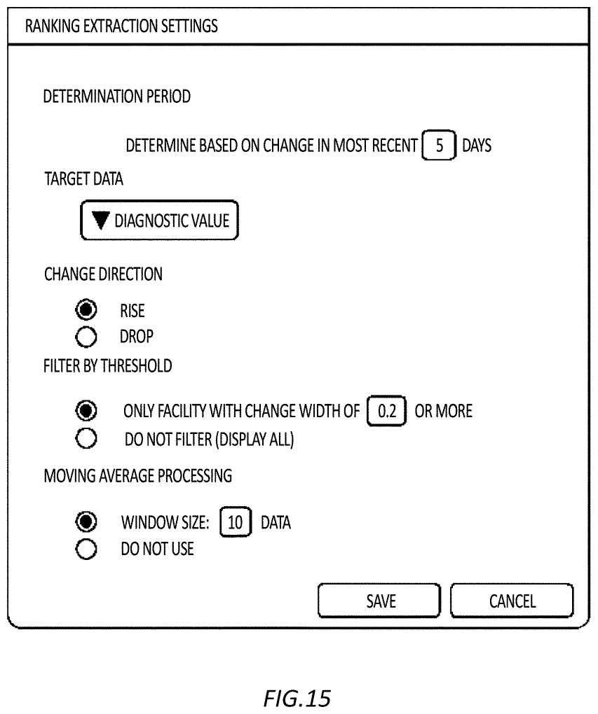

FIG. 15 shows an example of a detection condition designation screen according to a modification of the present embodiment. The output unit 144 may perform processing of displaying the detection condition designation screen of this figure instead of the detection condition designation screen of FIG. 11.

Similarly to FIG. 11, the detection condition designation screen accepts the length of the determination period by using “determination period” field. Moreover, the detection condition designation screen accepts designation as to whether to select the diagnostic value of each facility 100 as the state value to be displayed or to select the measurement value of each sensor 110 as the state value, by using “target data” field. In a case where it is designated to select the measurement value from each sensor 110 as the state value, the monitoring apparatus 140 performs various types of processing described in relation to FIGS. 1 to 14 by using the measurement value as the state value instead of the diagnostic value.

Moreover, the detection condition designation screen accepts selection as to whether to set, as a detection target, a state value having risen by the determination threshold or more or to set, as the detection target, a state value having dropped by the determination threshold or more by using “change direction” field. When the detection condition input unit 145 inputs an instruction to set, as the detection target, a state value having risen by the determination threshold or more, the first identification executing unit 1431 detects a state value which has changed by a rise width or a rise rate of the determination threshold or more during the determination period. When the detection condition input unit 145 inputs an instruction to set, as the detection target, a state value having dropped by the determination threshold or more, the first identification executing unit 1431 detects a state value which has changed by a drop width or a drop rate of the determination threshold or more during the determination period.

Moreover, similarly to FIG. 11, the detection condition designation screen accepts the determination threshold by using “filter by threshold” field. Moreover, by using “moving average processing” field, the detection condition designation screen accepts designation as to whether to subject the state value (instantaneous value) at each timing as it is to the detection by the first identification executing unit 1431, the display by the output unit 144, or the like or to subject, as the state value to be processed, a result of taking the moving average of the state value (instantaneous value) at each timing to these types of processing.

When “not use” is selected in “moving average processing” field, the input unit 145 instructs the calculation unit 1430 to output, as the state value, the instantaneous value of the state value calculated for each timing. Consequently, the calculation unit 1430 outputs the instantaneous value of the state value calculated for each timing as the state value to be processed, as it is. When “window size: (blank) data” is selected in “moving average processing” field and the number of samples of the instantaneous value for which the moving average is to be taken is designated in (blank), the input unit 145 instructs the calculation unit 1430 to output, as the state value to be processed, a result of taking the moving average of the instantaneous value of the state value calculated for each timing for the number of samples designated in (blank). For example, in a case where 10 is designated as the number of samples in (blank) as shown in this figure, the input unit 145 instructs the calculation unit 1430 to output, as the state value to be processed at the time t, an average value of instantaneous values of the most recent 10 samples at times t, t−1, . . . , and t−9. In response to receiving such an instruction, the calculation unit 1430 calculates a moving average value of the instantaneous value of the state value at each timing, to output it as the state value to be processed.

Accordingly, even in a case where the measurement value or the diagnostic value used as the state value does not change smoothly, the monitoring apparatus 140 can detect, sort, and display the state value based on the trend of the change in the state value by performing the moving average processing.

### Modification

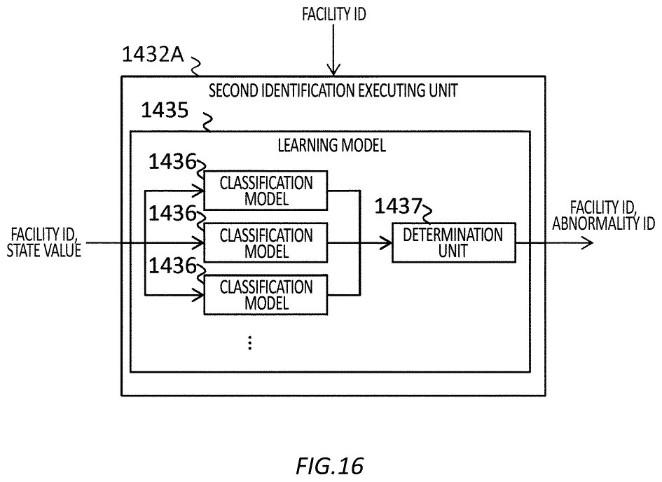

FIG. 16 shows a second identification executing unit 1432A according to the modification. Instead of the second identification executing unit 1432, the second identification executing unit 1432A may be used in the monitoring apparatus 140 in the above-described embodiment.

The second identification executing unit 1432A identifies an abnormality type of abnormality having occurred in at least one facility 100 (also referred to as the target facility 100) by using a learning model 1435. The second identification executing unit 1432A may include the learning model 1435. Note that, in this modification, as an example, each facility 100 of the monitoring system 10 will be described as the target facility 100.

The learning model 1435 is generated by learning processing using learning data including the data set 1420 for the target facility 100, and outputs an abnormality type corresponding to the supplied measurement value. In this modification, as an example, the learning model 1435 includes a plurality of classification models 1436 and a determination unit 1437.

Each classification model 1436 is provided for each abnormality type, and, based on a supplied measurement value, classifies whether or not abnormality of the corresponding abnormality type has occurred. Each classification model 1436 may be generated by supervised learning using a data set in a case where the abnormality of the corresponding abnormality type has occurred and a data set in a case where no abnormality of the corresponding abnormality type occurs. Each classification model 1436 may output a classification result as to whether or not the abnormality of the corresponding abnormality type has occurred, in response to the measurement value being supplied. As an example, each classification model may be an SVM.

Here, each classification model 1436 according to this modification is provided for each facility 100 in addition to being provided for each abnormality type, and is generated by using a data set in a case where the abnormality of the corresponding abnormality type has occurred in the corresponding facility 100 and a data set in a case where no abnormality of the corresponding abnormality type occurs in the corresponding facility 100. In response to the facility ID of the corresponding facility 100 being supplied from the first identification executing unit 1431, each classification model 1436 may acquire the measurement value of the facility 100 from the calculation unit 1430 and output a classification result as to whether or not the abnormality of the corresponding abnormality type has occurred.

The determination unit 1437 determines which abnormality type of abnormality has occurred, based on the classification result by each classification model 1436. The determination unit 1437 may detect the classification model 1436 that has output the classification result indicating that the abnormality has occurred, and determine the abnormality type corresponding to the classification model 1436 as the abnormality type of the abnormality having occurred. The determination unit 1437 may output the abnormality ID indicating the abnormality type of the abnormality having occurred, together with the facility ID supplied from the first identification executing unit 1431, that is, the facility ID of the facility 100 in which the abnormality has occurred.

According to the above modification, the abnormality type of the abnormality having occurred in the facility 100 is identified by using the learning model 1435 generated by the learning processing using the learning data including the data set 1420 for at least one facility 100. Therefore, the abnormality type can be identified accurately.

Moreover, the learning model 1435 includes the classification model 1436 that is provided for each abnormality type and classifies whether or not abnormality of the corresponding abnormality type has occurred, based on a supplied measurement value. Therefore, the occurrence of abnormality of each abnormality type can be identified reliably.

Note that, in the above-described modification, since the learning model 1435 is generated by the learning processing using the learning data including the data set 1420, the second identification executing unit 1432A identifies any abnormality type included in the data set 1420 of the learning data as the abnormality type of the abnormality having occurred in the abnormal facility 100. However, the second identification executing unit 1432 may identify a new abnormality type not included in any data set 1420. As an example, in a case where the abnormality type cannot be identified by using the learning model 1435 even though the abnormal facility 100 is identified by the first identification executing unit 1431, the second identification executing unit 1432 may identify that abnormality of a new abnormality type has occurred. Instead, when the most recent measurement value is an outlier that deviates from the measurement value of each data set 1420 by a reference value or more, the second identification executing unit 1432 may identify that the abnormality of the new abnormality type has occurred. In this case, the second identification executing unit 1432 may have a model that is generated by unsupervised learning using, as learning data, the measurement value of each data set 1420 in the storage unit 142 and determines whether or not the most recent measurement value is an outlier.

### Other Modifications

Note that, in the above-described embodiment and modification, the description has been given assuming that the first identification executing unit 1431 detects, as a state value indicating the occurrence of abnormality, a state value that has changed by a predetermined change width or change rate or more during a period of a predetermined time length, but another state value may be detected. For example, the first identification executing unit 1431 may detect a state value outside a preset reference range as the state value indicating the occurrence of the abnormality.

Moreover, the description has been given assuming that the second identification executing unit 1432 identifies an abnormality type by either performing cluster analysis or using the learning model 1435 for each facility 100 in the monitoring system 10, but the abnormality type may be identified by performing cluster analysis for some facilities 100, and the abnormality type may be identified by using the learning model 1435 for other facilities 100.

Moreover, the description has been given assuming that the identification unit 143 identifies the facility 100 in which the abnormality has occurred, by the first identification executing unit 1431 and identifies the abnormality type by the second identification executing unit 1432, but the identification of the facility 100 in which the abnormality has occurred and the identification of the abnormality type may be performed together. For example, the identification unit 143 may collectively identify the occurrence of abnormality in at least one facility 100 and the abnormality type of the abnormality by cluster analysis using each data set 1420 stored for the at least one facility 100. Instead, the identification unit 143 may identify the occurrence of abnormality in at least one facility and the abnormality type of the abnormality by using the learning model 1435 generated by learning processing using learning data including a data set for the at least one facility.

Moreover, the description has been given assuming that the monitoring apparatus 140 includes the storage unit 142, the learning processing unit 146, and the input unit 145, but the monitoring apparatus 140 may not include any of these. In a case where the monitoring apparatus 140 does not include the storage unit 142, the data set 1420 and the correspondence table 1421 may be stored in a storage apparatus externally connected to the monitoring apparatus 140. In a case where the monitoring apparatus 140 does not include the learning processing unit 146, the model of the calculation unit 1430 may be generated by learning processing in an external learning apparatus.

Various embodiments of the present invention may be described with reference to flowcharts and block diagrams, where blocks may represent (1) stages of processes in which operations are executed or (2) sections of apparatuses responsible for executing operations. Certain stages and sections may be implemented by a dedicated circuit, a programmable circuit supplied together with computer-readable instructions stored on computer-readable media, and/or processors supplied together with computer-readable instructions stored on computer-readable media. The dedicated circuit may include digital and/or analog hardware circuits, and may include integrated circuits (IC) and/or discrete circuits. The programmable circuit may include a reconfigurable hardware circuit including logical AND, logical OR, logical XOR, logical NAND, logical NOR, and other logical operations, a memory element or the like such as a flip-flop, a register, a field programmable gate array (FPGA) and a programmable logic array (PLA), or the like.

A computer-readable medium may include any tangible device that can store instructions to be executed by a suitable device, and as a result, the computer-readable medium having instructions stored thereon includes a product including instructions that can be executed in order to create means for executing operations specified in the flowcharts or block diagrams. Examples of the computer-readable medium may include an electronic storage medium, a magnetic storage medium, an optical storage medium, an electromagnetic storage medium, a semiconductor storage medium, and the like. More specific examples of the computer readable medium may include a FLOPPY (registered trademark) disk, a diskette, a hard disk, a random access memory (RAM), a read only memory (ROM), an erasable programmable read only memory (EPROM or a flash memory), an electrically erasable programmable read only memory (EEPROM), a static random access memory (SRAM), a compact disc read only memory (CD-ROM), a digital versatile disk (DVD), a BLU-RAY (registered trademark) disk, a memory stick, an integrated circuit card, and the like.

The computer-readable instruction may include: an assembler instruction, an instruction-set-architecture (ISA) instruction; a machine instruction; a machine dependent instruction; a microcode; a firmware instruction; state-setting data; or either a source code or an object code described in any combination of one or more programming languages, including an object oriented programming language such as Smalltalk (registered trademark), JAVA (registered trademark), C++, or the like, and a conventional procedural programming language such as a “C” programming language or a similar programming language.

The computer-readable instruction may be provided for a processor or programmable circuitry of a programmable data processing apparatus, such as a computer, locally or via a local area network (LAN), a wide area network (WAN) such as the Internet, or the like to execute the computer-readable instruction in order to create means for executing the operations specified in the flowcharts or block diagrams. Herein, the computer may be a personal computer (PC), a tablet computer, a smart phone, a workstation, a server computer, or a computer such as a general purpose computer or a special purpose computer, or may be a computer system to which a plurality of computers are connected. Such computer system to which the plurality of computers are connected is also referred to as a distributed computing system, and is a computer in a broad sense. In a distributed computing system, a plurality of computers collectively execute a program by each of the plurality of computers executing a portion of the program, and passing data during the execution of the program among the computers as needed.

Examples of the processor include a computer processor, a central processing unit (CPU), a processing unit, a microprocessor, a digital signal processor, a controller, a microcontroller, and the like. The computer may include one processor or a plurality of processors. In a multi-processor system including a plurality of processors, the plurality of processors collectively execute a program by each of the processors executing a portion of the program, and passing data during the execution of the program among the processors as needed. For example, in execution of multiple tasks, each of the plurality of processors may execute a portion of each task pieces by pieces by performing task-switching for each time slice. In this case, which portion of one program each processor is responsible for executing dynamically changes. Moreover, which portion of the program each of the plurality of processor is responsible for executing may be determined statically by multi-processor-aware programming.

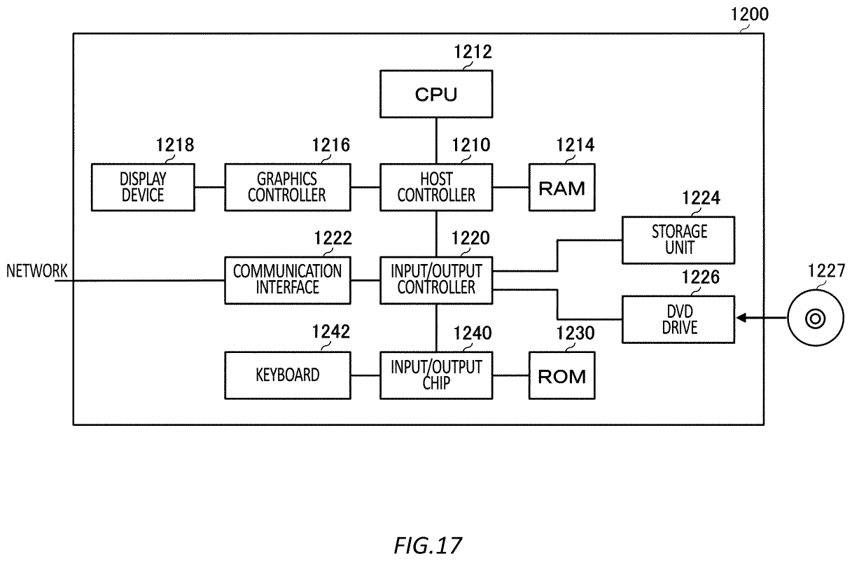

FIG. 17 shows an example of a computer 1200 in which a plurality of aspects of the present invention may be entirely or partially embodied. A program which is installed in the computer 1200 can cause the computer 1200 to function as one or more “sections” in an operation or an apparatus associated with the embodiment according to the present invention, or can cause the computer 1200 to perform the operation or the one or more sections of the apparatus, and/or can cause the computer 1200 to perform processes or steps of the processes of the embodiment according to the present invention. Such a program may be performed by a CPU 1212 so as to cause the computer 1200 to perform certain operations associated with some or all of the blocks of flowcharts and block diagrams described herein.

The computer 1200 according to the present embodiment includes a CPU 1212, a RAM 1214, a graphics controller 1216, and a display device 1218, which are mutually connected by a host controller 1210. The computer 1200 also includes a storage unit 1224 such as a communication interface 1222, a hard disk drive, or the like, an input/output unit such as a DVD-ROM drive 1226 and the IC card drive, which are connected to a host controller 1210 via an input/output controller 1220. The computer also includes legacy input/output units such as an ROM 1230 and a keyboard 1242, which are connected to the input/output controller 1220 via an input/output chip 1240.

The CPU 1212 operates according to programs stored in the ROM 1230 and the RAM 1214, thereby controlling each unit. The graphics controller 1216 acquires image data generated by the CPU 1212 on a frame buffer or the like provided in the RAM 1214 or in itself, and causes the image data to be displayed on a display device 1218.

The communication interface 1222 communicates with other electronic devices via a network. The storage unit 1224 stores the program and data used by the CPU 1212 within the computer 1200. The DVD-ROM drive 1226 reads the program or data from the DVD-ROM 1227 and provides the program or data to the storage unit 1224 via the RAM 1214. The IC card drive reads the programs and the data from the IC card, and/or writes the programs and the data to the IC card.

The ROM 1230 stores therein a boot program or the like that is performed by the computer 1200 at the time of activation, and/or a program depending on the hardware of the computer 1200. The input/output chip 1240 may also connect various input/output units to the input/output controller 1220 via a parallel port, a serial port, a keyboard port, a mouse port, or the like.

Programs are provided by a computer readable medium such as the DVD-ROM 1227 or the IC card. The program is read from the computer readable medium, is installed on the storage unit 1224, a RAM 1214, or a ROM 1230, which are an example of a computer readable medium, and is executed by the CPU 1212. Information processing described in these programs is read by the computer 1200, and provides cooperation between the programs and the various types of hardware resources described above. An apparatus or method may be constituted by implementing the operation or processing of information in accordance with the usage of the computer 1200.

For example, when communication is performed between the computer 1200 and an external device, the CPU 1212 may perform a communication program loaded onto the RAM 1214 to instruct communication processing to the communication interface 1222, based on the processing written in the communication program. The communication interface 1222 reads the transmission data stored in a transmission buffer processing region provided on a recording medium such as a RAM 1214, the storage unit 1224, a DVD-ROM 1227, or an IC card under the control of a CPU 1212, transmits the read transmission data to the network, or writes the reception data received from the network to a reception buffer processing region or the like provided on a recording medium.

In addition, the CPU 1212 may cause the RAM 1214 to read all or a necessary part of a file or database stored in an external recording medium such as the storage unit 1224, the DVD-ROM drive 1226 (DVD-ROM 1227), the IC card, or the like, and may execute various types of processing on data on the RAM 1214. The CPU 1212 then writes back the processed data to the external recording medium.

Various types of information such as various types of programs, data, tables, and databases may be stored in a recording medium and subjected to information processing. The CPU 1212 may perform various types of processing on the data read from the RAM 1214, which includes various types of operations, information processing, conditional judging, conditional branching, unconditional branching, search/replace of information, etc., as described throughout this disclosure and designated by an instruction sequence of programs, and writes the result back to the RAM 1214. In addition, the CPU 1212 may search for information in a file, a database, or the like in the recording medium. For example, when a plurality of entries, each having an attribute value of a first attribute associated with an attribute value of a second attribute, are stored in the recording medium, the CPU 1212 may retrieve, out of the plurality of entries, an entry with the attribute value of the first attribute specified that meets a condition, read the attribute value of the second attribute stored in said entry, and thereby acquiring the attribute value of the second attribute associated with the first attribute satisfying a predetermined condition.

The above-explained program or software modules may be stored in the computer readable media on or near the computer 1200. In addition, a recording medium such as a hard disk or a RAM provided in a server system connected to a dedicated communication network or the Internet can be used as the computer readable media, thereby providing the program to the computer 1200 via the network.

While the present invention has been described by way of the embodiments, the technical scope of the present invention is not limited to the above-described embodiments. It is apparent to persons skilled in the art that various alterations or improvements can be made to the above-described embodiments. It is also apparent from description of the claims that the embodiments to which such modifications or improvements are made may be included in the technical scope of the present invention.

It should be noted that each process of the operations, procedures, steps, stages, and the like performed by the apparatus, system, program, and method shown in the claims, specification, or drawings can be executed in any order as long as the order is not indicated by “prior to”, “before”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

10: monitoring system;
100: facility;
110: sensor;
120: gateway apparatus;
130: network;
140: monitoring apparatus;
141: acquisition unit;
142: storage unit;
143: identification unit;
144: output unit;
145: input unit;
146: learning processing unit;
150: terminal;
500: display screen;
510: list;
515: setting button;
520: graph display button;
530: change button;
540: exclusion button;
550: learning button;
1200: computer;
1210: host controller;
1212: CPU;
1214: RAM;
1216: graphics controller;
1218: display device;
1220: input/output controller;
1222: communication interface;
1224: storage unit;
1226: DVD-ROM drive;
1227: DVD-ROM;
1230: ROM;
1240: input/output chip;
1242: keyboard;
1420: data set;
1421: correspondence table;
1430: calculation unit;
1431: first identification executing unit;
1432: second identification executing unit;
1433: third identification executing unit;
1435: learning model;
1436: classification model; and
1437: determination unit.

What is claimed is:

1. An apparatus comprising a processor, wherein the processor performs operations comprising:
acquiring measurement values corresponding to outputs of a plurality of sensors for monitoring states of a plurality of facilities;
identifying, based on the measurement values acquired in the acquiring, which abnormality type of abnormality among a plurality of abnormality types determined in advance has occurred in which facility among the plurality of facilities; and
outputting information indicating the facility and the abnormality type identified in the identifying.

2. The apparatus according to claim 1, wherein the identifying includes identifying, for at least one facility, which abnormality type of abnormality among two or more abnormality types determined in advance has occurred.

3. The apparatus according to claim 1, wherein
the identifying includes
calculating a state value for each facility based on the measurement value acquired in the acquiring,
executing a first identification for identifying a facility in which abnormality has occurred, based on the state value of each facility;
executing a second identification for identifying, for the facility identified in the executing the first identification, which abnormality type of abnormality has occurred.

4. The apparatus according to claim 2, wherein
the identifying includes
calculating a state value for each facility based on the measurement value acquired in the acquiring,
executing a first identification for identifying a facility in which abnormality has occurred, based on the state value of each facility;
executing a second identification for identifying, for the facility identified in the executing the first identification, which abnormality type of abnormality has occurred.

5. The apparatus according to claim 3, wherein the executing the first identification includes identifying, among the plurality of facilities, a facility in which a state value has changed by a predetermined change width or change rate or more during a period of a predetermined time length, as a facility in which abnormality has occurred.

6. The apparatus according to claim 4, wherein the executing the first identification includes identifying, among the plurality of facilities, a facility in which a state value has changed by a predetermined change width or change rate or more during a period of a predetermined time length, as a facility in which abnormality has occurred.

7. The apparatus according to claim 1, wherein the processor further performs operations comprising:
storing, for at least one facility, a plurality of data sets including a data set in which a measurement value in a case where abnormality has occurred in past and an abnormality type of the abnormality are associated with each other, wherein
the identifying includes identifying an abnormality type of abnormality having occurred in the at least one facility by cluster analysis using each data set stored in the storing.

8. The apparatus according to claim 2, wherein the processor further performs operations comprising:
storing, for at least one facility, a plurality of data sets including a data set in which a measurement value in a case where abnormality has occurred in past and an abnormality type of the abnormality are associated with each other, wherein
the identifying includes identifying an abnormality type of abnormality having occurred in the at least one facility by cluster analysis using each data set stored in the storing.

9. The apparatus according to claim 3, wherein the processor further performs operations comprising:
storing, for at least one facility, a plurality of data sets including a data set in which a measurement value in a case where abnormality has occurred in past and an abnormality type of the abnormality are associated with each other, wherein
the identifying includes identifying an abnormality type of abnormality having occurred in the at least one facility by cluster analysis using each data set stored in the storing.

10. The apparatus according to claim 1, wherein the identifying includes identifying, for at least one facility, an abnormality type of abnormality having occurred in the at least one facility by using a learning model that is generated by learning processing using learning data including a data set in which a measurement value in a case where abnormality has occurred in past and an abnormality type of the abnormality are associated with each other and that outputs an abnormality type corresponding to a supplied measurement value.

11. The apparatus according to claim 2, wherein the identifying includes identifying, for at least one facility, an abnormality type of abnormality having occurred in the at least one facility by using a learning model that is generated by learning processing using learning data including a data set in which a measurement value in a case where abnormality has occurred in past and an abnormality type of the abnormality are associated with each other and that outputs an abnormality type corresponding to a supplied measurement value.

12. The apparatus according to claim 3, wherein the identifying includes identifying, for at least one facility, an abnormality type of abnormality having occurred in the at least one facility by using a learning model that is generated by learning processing using learning data including a data set in which a measurement value in a case where abnormality has occurred in past and an abnormality type of the abnormality are associated with each other and that outputs an abnormality type corresponding to a supplied measurement value.

13. The apparatus according to claim 10, wherein the learning model includes a classification model that is provided for each abnormality type and that classifies whether or not abnormality of a corresponding abnormality type has occurred, based on the supplied measurement value.

14. The apparatus according to claim 11, wherein the learning model includes a classification model that is provided for each abnormality type and that classifies whether or not abnormality of a corresponding abnormality type has occurred, based on the supplied measurement value.

15. The apparatus according to claim 12, wherein the learning model includes a classification model that is provided for each abnormality type and that classifies whether or not abnormality of a corresponding abnormality type has occurred, based on the supplied measurement value.

16. The apparatus according to claim 1, wherein the processor further performs operations comprising:
storing each of the plurality of abnormality types in association with urgency of abnormality in advance, wherein
the identifying includes further identifying an urgency associated with an identified abnormality type, and
the outputting includes further outputting the urgency identified in the identifying.

17. The apparatus according to claim 2, wherein the processor further performs operations comprising:
storing each of the plurality of abnormality types in association with urgency of abnormality in advance, wherein
the identifying includes further identifying an urgency associated with an identified abnormality type, and
the outputting includes further outputting the urgency identified in the identifying.

18. The apparatus according to claim 3, wherein the processor further performs operations comprising:
storing each of the plurality of abnormality types in association with urgency of abnormality in advance, wherein
the identifying includes further identifying an urgency associated with an identified abnormality type, and
the outputting includes further outputting the urgency identified in the identifying.

19. A method comprising:
acquiring measurement values corresponding to outputs of a plurality of sensors for monitoring states of a plurality of facilities;
identifying, based on the measurement values acquired in the acquiring, which abnormality type of abnormality among a plurality of abnormality types determined in advance has occurred in which facility among the plurality of facilities; and
outputting information indicating the facility and the abnormality type identified in the identifying.

20. A non-transitory computer readable medium having recorded thereon a program which, when executed by a computer, causes the computer to perform operations comprising:
acquiring measurement values corresponding to outputs of a plurality of sensors for monitoring states of a plurality of facilities;
identifying, based on the measurement values acquired in the acquiring, which abnormality type of abnormality among a plurality of abnormality types determined in advance has occurred in which facility among the plurality of facilities; and
outputting information indicating the facility and the abnormality type identified in the identifying.
